(19) United States
(12) Patent Application Publication
(10) Pub. No.: US 2023/0033078 A1
(43) Pub. Date: Feb. 2, 2023

(54) REDIRECTING REQUESTS TO A FAIL-SAFE WEBSITE

(71) Applicant: Capital One Services, LLC, McLean, VA (US)

(72) Inventors: Qiaochu TANG, The Colony, TX (US); Geoffrey DAGLEY, Mckinney, TX (US); Avid GHAMSARI, Frisco, TX (US)

(73) Assignee: Capital One Services, LLC, McLean, VA (US)

(21) Appl. No.: 17/391,222

(22) Filed: Aug. 2, 2021

(51) Int. Cl. G06F 16/957; G06F 16/958; G06F 16/955

(52) U.S. Cl. CPC G06F 16/9577; G06F 16/958; G06F 16/955

(57) ABSTRACT

Disclosed herein are system, method, and computer program product embodiments for identifying an operational error on a website. In a given embodiment, a server may receive requests from a first website. The server identifies an attribute associated with the requests from the first website. The server may receive an HTML, file including content of the first website from a web-component. The server may identify an operational error with the first website based on the attribute and the content of the first website. Furthermore, the server may redirect an attempt to access the first website to a second website using the web-component.

### BACKGROUND

Many entities have websites without a backup or fail-safe system. Users may access the websites to interact with the different webpages of the website. However, when the website crashes or malfunctions and the entity does not have a backup or fail-safe system, the users cannot access and interact with the website. As a result, this causes downtime and loss of users' access to the website. The downtime may be devastating to small businesses.

### BRIEF DESCRIPTION OF THE DRAWINGS

The accompanying drawings are incorporated herein and form a part of the specification.

FIG. 1 is a block diagram of a system for identifying an operational error on a website, according to some embodiments.

FIG. 2 is a block diagram illustrating the data flow in the system for identifying an operational error on a website, according to some embodiments.

FIG. 3 illustrates a graphical user interface of a first domain's website, according to some embodiments.

FIG. 4 is a flowchart illustrating a process for identifying an operational error with a first website, according to some embodiments.

FIG. 5 is a flowchart illustrating a process for redirecting an attempt to access a first website to a second website, according to some embodiments, according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, identifying an operational error on a website.

Entities often provide e-commerce capabilities through websites. For example, a user may access a car dealership's website to view their inventory of vehicles for sale. The user may view, inquire about, and purchase a vehicle through the car dealership's website. However, if the car dealership's website crashes or is inoperable, a user may not be able to access the car dealership's inventory. This may cause the car dealership to miss out on potential customers. Moreover, the car dealership may be unaware of the operational error.

The method, system, and non-transitory computer-readable medium embodiments described herein solve these problems by determining that a first website of a first domain has an operational error and redirecting users to a second website, mirroring the first website, while the operational error exists on the first website. In a given embodiment, a server may receive requests from a first website. The first website is a first property of a first domain. The server identifies an attribute associated with the requests from the first website. The server may receive an HTML file including the content of the first website from a web-component configured to extract the first website's content in response to executing code embedded in the first website. The code is a second property of a second domain. The server may identify an operational error with the first website based on the attribute and the first website's content. Furthermore, the server may redirect an attempt to access the first website to a second website using the web-component. The second website is a third property of the second domain.

This configuration allows for users to be redirected to the second website, which mirrors the first website. Users may interface with the second website as they would the first website Moreover, this configuration allows for the car dealership to be notified of the operational error so that the operational error may be resolved as quickly as possible. By doing so, the entity associated with the first website does not encounter a significant amount of downtime.

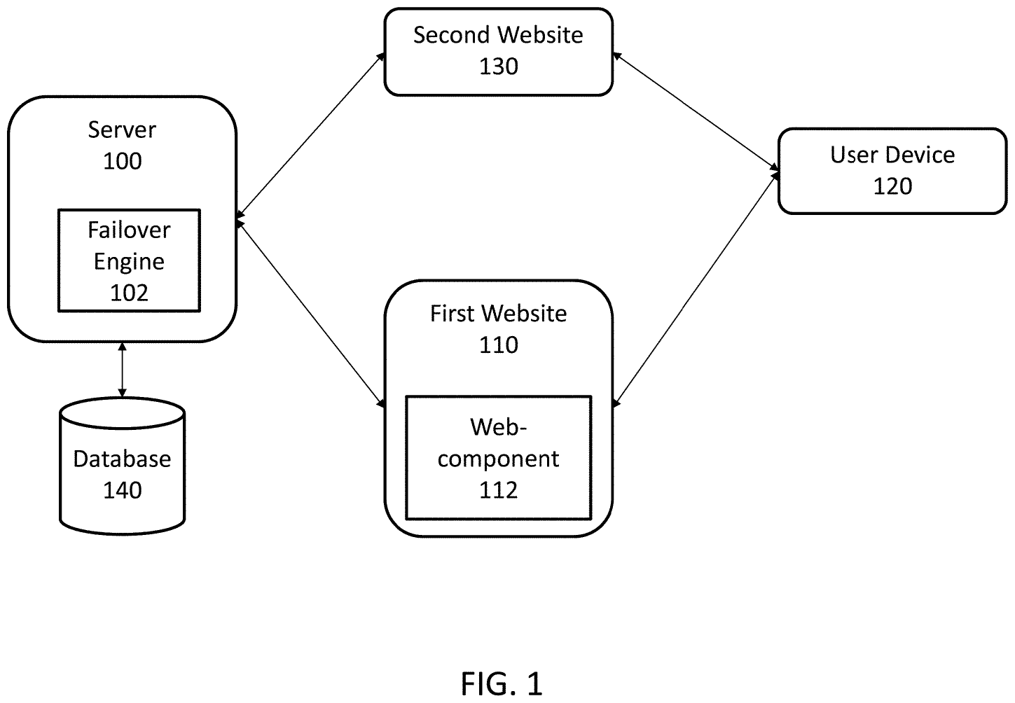

FIG. 1 is a block diagram of a system for identifying an operational error on a website, according to some embodiments. In an embodiment, the system can include a server 100, user device 120, and database 140. User device 120 may be configured to access first website 110 and second website 130. First website 110 and second website 130 may be in communication with server 100. Server 100 may be in communication with database 140.

First website 110 may be hosted by a third-party server and may be accessible to user device 120 through a portion of the Internet or other network. Moreover, first website 110 may be a property of a first domain. Second website 130 may be hosted by server 100 or a different server and may be accessible to user device 120 through a portion of the Internet or other network. Second website 130 may be the property of a second domain. Second website 130 may be associated with server 100. Server 100 may be in communication with first website 110 and second website 130 through a different or same portion of the Internet or some other network.

Server 100 and database 140 can be connected through wired connections, wireless connections, or a combination of wired and wireless connections. As an example, server 100 and database 140 can be connected through a network. The network can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

User device 120 may be configured to access first website 110 or second website 130 through an application executing on user device 120, such as an internet browser. In some embodiments, user device 120 may be configured to access first website 110 using a web-based application executing on user device 120.

First website 110 may be a third-party website. The third-party may be the first domain. First website 110 may include information about one or more items available at the first domain. An entity associated with server 100 may provide an executable code to the administrator of first website 110. The executable code may be embedded in first website 110 as a web-component 112. Web-component 112 may be associated with server 100. As a non-limiting example, web-component 112 may be a JavaScript web component.

Web-component 112 may be the property of the second domain. The second domain may provide web-component 112 to the first domain to embed on first website 110.

Web-component 112 may include instructions to include a GUI element on first website 110 each time first website 110 is loaded on user device 120. Web-component 112 may also include instructions to execute an automated script each time first website 110 is loaded on user device 120. The automated script may be configured to execute a web-scraping algorithm to scrape the content of the webpage and generate an HTML file including the content of the webpage. For example, web-component 112 may implement a SCRAPY application developed in Python. The SCRAPY application is a web-crawler framework that is configured to scrape data from websites. First website 110 may be configured to transmit the HTML file to server 100 each time an HTML file is generated. That is, web-component 112 may be executed each time first website 110 is loaded on user device 120. In some embodiments, web-component 112 may not render a GUI element and may execute the automated script in the background.

As a non-limiting example, the first domain may be a car dealership and first website 110 may be a car dealership's website configured to render information about vehicles available for sale at the car dealership. The second domain, or the entity associated with server 100 may be a financial institution, which provides loans for purchasing vehicles from the car dealership. The dealership website. The duplicate site may provide the car dealership with the ability to swap sites when the car dealership's website experiences downtime. The second domain may provide executable code to the car dealership to be embedded in first website 110 (e.g., the car dealership's website). Once embedded in first website 110, the executable code may be a web-component 112. The web-component 112 may include instructions for rendering a GUI element (e.g., a button) on first website 110 (e.g., the car dealership's website). The user may select the GUI element to transmit a request to generate a loan.

Specifically, in response to the GUI element being selected, a request may be transmitted to server 100. The request may be for generating prequalification results for an item on the webpage of first website 110. The GUI element may include information about the specific item. For example, the item may be a vehicle and the properties of the GUI element may include information such as product name, VIN number, price, physical details, and/or the like.

In response to receiving the request, server 100 may generate a call to a different application or website. Server 100 may receive the information about the specific product and third party domain from the properties of the button, in response to actuation of the button. The different application or website may be rendered on the user device 120 by embedding the different website or application in the first website 110. The different website or application may be embedded in first website 110 as an Iframe.

The GUI element may use Open Authentication (OAuth). In this regard, while the GUI element may reside on first website 110, the GUI element and the different website or application may be associated with server 100. Furthermore, the GUI element and the different website or application may be owned and operated by an entity associated with server 100.

Web-component 112 may include instructions to execute an automated script, which is configured to extract the content of the webpage of first website 110 (e.g., the car dealership website) and generate an HTML, file including the content of the webpage of first website 110. The content may include information about the vehicles for sale at the car dealership. Web-component 112 may include instructions to transmit the HTML file to server 100.

Server 100 may receive an HTML file including the content of the first website 110 from web-component 112. The content may include a first set of data about items available at the first domain. Server 100 may execute a failover engine 102. Failover engine 102 may identify discrepancies in the content included in the HTML file. For example, the discrepancies may include an absence of content, garbled text, unexpected formatting, or the like. In this regard, in response to failover engine 102 identifying more than a threshold number of blank spaces, incoherent text, unexpected artifacts or elements, or the like, in the HTML file, failover engine 102 may identify one or more discrepancies in the HTML file.

In some embodiments, failover engine 102 may identify the discrepancies based on a predefined set of rules. The predefined set of rules may indicate circumstances where discrepancies may exist in the HTML file. The circumstances may be more than a threshold number of blank spaces, incoherent text, unexpected artifacts or elements, or the like.

Moreover, the predefined set of rules may indicate the circumstances of when the identified discrepancies are caused by or causing an operational error with first website 110. For example, failover engine 102 may identify a discrepancy of more than a threshold number of blank spaces in the HTML file. More than a threshold number of blank spaces may indicate that first website 110 is not displaying any data, based on the predefined set of rules. As a result, an operational error may exist on first website 110. Alternatively, failover engine 102 may identify a discrepancy of an unexpected artifact in the HTML file. The unexpected artifact may be an extra character or space. As a result, the predefined set of rules may indicate that the unexpected artifact does not indicate that there is an operational error on first website 110.

Furthermore, as indicated above, web-component 112 may render a GUI element on first website 110. The executable code of web-component 112 may be tailored to first website 110. This way, web-component 112 may render the GUI element at an appropriate location on first website 110. A user may interact with the GUI element to transmit a request to server 100. As a non-limiting example, the request may be a prequalification request for a loan for a vehicle. In the event that there is an operational error on first website 110, the GUI element may not be rendered on first website 110. As a result, server 100 may receive fewer requests from first website 110.

Failover engine 102 may identify an attribute associated with the requests received from first website 110. The attribute may indicate that a lower than a threshold amount of requests received over a period of time or from a specified geographic region. Failover engine 102 may use the attribute and the identified discrepancy to determine that there is an operational error with first website 110. Failover engine 102 may redirect any attempt to access first website 110 from user device 120 or any other device to second website 130, in response to identifying the operational error with first website 110 and while the operational error remains on first website 110.

Second website 130 may mirror the content of first website 110. Alternatively, the second website 130 may be a car shopping application, for example, provided by a financial institution (e.g., Capital One Auto Navigator). As a non-limiting example, first website 110 may be a car dealership's website and may render information about vehicles available at the car dealership. A user may interact with first website 110 to view, inquire about, and/or purchase a vehicle at the car dealership. Similarly, second website 130 may include the vehicles available at the car dealership. A user may interact with second website 130 to view, inquire about, and/or purchase a vehicle at the car dealership.

First website 110 and second website 130 may have different website addresses and may be different and distinct websites. Moreover, first website 110 may be unaffiliated with server 100, while second website 130 may be associated with server 100. As a non-limiting example, server 100 may be associated with a financial institution, such as a bank. The bank may host and administer second website 130. With the car dealership's permission, second website 130 may include the car dealership vehicles.

Database 140 may be one or more data storage devices configured to store data. More specifically, database 140 may be configured to store data associated with items available at various domains (e.g., third-parties). As a non-limiting example, the items may be vehicles available at a car dealership. The data stored in database 140 may include, make of a vehicle, model of the vehicle, year of the vehicle, price of the vehicle, color of the vehicle, quantity of the vehicle available at the car dealership, or the like. Second website 130 may render items available at a particular domain based on the data stored in database 140.

Database 140 may also be configured to store information about requests received from first website 110. The information may include the content of the requests or the number of requests received over a period of time or from a geographic region. Failover engine 102 may use the information to determine whether an operational error exists on first website 110.

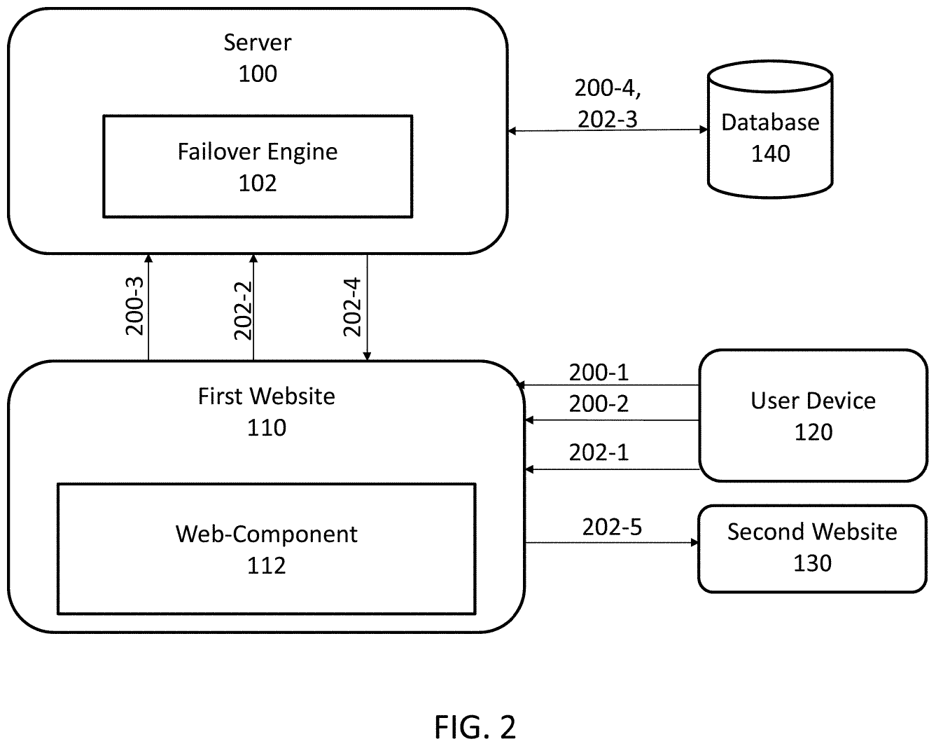

FIG. 2 is a block diagram of data flow in the system for identifying an operational error on a website, according to some embodiments. In a given embodiment, user device 120 may transmit a request 200-1 to first website 110 to access first website 110. In response to accessing first website 110, first website 110 may be loaded on user device 120. In response to loading on user device 120, web-component 112 may execute the executable code embedded in first website 110. The executable code may execute a web-scraping algorithm to scrape the content of the webpage of first website 110 loaded on user device 120. Web-component 112 may generate an HTML file including the content. Moreover, web-component 112 may execute the executable code to render a GUI element on the webpage of first website 110, such as a button on a webpage of first website 110. Web-component 112 may be executed on one or more webpages of first website 110.

User device 120 may interact with the GUI element. For example, user device 120 may select the button rendered on the webpage of first website 110 to transmit a request to server 100. As a non-limiting example, first website 110 may be a car dealership's website. The GUI element may be selected to transmit a prequalification request to server 100 for receiving prequalification for a loan for a vehicle sold by the car dealership. User device 120 may transmit request 200-2 to first website 110 in response to selecting the GUI element. First website 110 may transmit request 200-3 to server 100 in response to receiving the selection of the GUI element. Request 200-3 may also include the HTML file generated by web-component 112.

Server 100 may receive request 200-3. Failover engine 102 may transmit request 200-4 to database 140 to store the data of request 200-3. The data of request 200-3 may include a geographic location of user device 120 (e.g., where the request originated) and a timestamp of request 200-3. The data may also include information necessary for generating a prequalification result, such as user information and information about a specified vehicle. Server 100 may receive prequalification requests from other users from other geographic regions. The data of these requests may be stored in database 140.

Failover engine 102 may also analyze the content included in the HTML file generated by web-component 112. In the event that the failover engine 102 determines that there are no discrepancies in the HTML file, failover engine 102 may store the HTML file in database 140.

First website 110 may receive request 202-1 from user device 120 to access first website 110. In response to first website 110 loading on user device 120, web-component 112 may execute the executable code embedded in first website 110. The executable code may execute a web-scraping algorithm to scrape the content of the webpage of first website 110 loaded on user device 120. Web-component 112 may generate an HTML file including the content. Moreover, web-component 112 may execute the executable code to render a GUI element on the webpage of first website 110. Failover engine 102 may transmit the HTML file to server 100 in request 202-2.

Server 100 may receive request 202-2. Failover engine 102 may analyze the content included in the HTML file received in request 202-2. Failover engine 102 may identify one or more discrepancies in the HTML file received in request 202-2. The discrepancies may be unintelligible text, the absence of content, unexpected formatting, or the like.

For example, in response to failover engine 102 identifying more than a threshold number of blank spaces, incoherent text, unexpected artifacts or elements, or the like, in the HTML file, failover engine 102 may identify one or more discrepancies in the content in the HTML file.

In some embodiments, failover engine 102 may identify the discrepancies based on a predefined set of rules. The predefined set of rules may indicate circumstances where discrepancies may exist in the HTML file. The circumstances may be more than a threshold number of blank spaces, incoherent text, unexpected artifacts or elements, or the like.

Moreover, the predefined set of rules may indicate the circumstances of when the identified discrepancies are caused by or causing an operational error with first website 110. For example, failover engine 102 may identify a discrepancy of more than a threshold number of blank spaces in the HTML file. More than a threshold number of blank spaces may indicate that first website 110 is not displaying any data, based on the predefined set of rules. As a result, an operational error may exist on first website 110. Alternatively, failover engine 102 may identify a discrepancy of an unexpected artifact in the HTML file. The unexpected artifact may be an extra character or space. As a result, the predefined set of rules may indicate that the unexpected artifact does not indicate that there is an operational error on first website 110.

Failover engine 102 may transmit request 202-3 to database 140 to retrieve data associated with requests (e.g., prequalification requests) received from user devices (including user device 120) over a period of time (e.g., last 60 minutes, last 5 days, last 15 minutes, etc.). As indicated above, the data may include geographic regions where the requests originated and a timestamp of the request.

Failover engine 102 may determine an attribute associated with the requests. For example, the attribute may indicate that server 100 received less than a threshold number of requests over a time period (or timeframe). The attribute may also indicate that more than a threshold number of requests received by server 100 included corrupt data. As another example, the attribute may indicate that server 100 received less than a threshold number of requests over a time period from a particular geographic region.

Failover engine 102 may determine that an operational error exists on first website 110 based on the identified discrepancies in the content of the HTML file and identified attribute about the request. The operational error may be an outage of first website 110, outage of first website 110 in a particular geographic region, corrupt or unintelligible data being rendered on first website 110, or first website 110 is providing limited functionality.

Server 100 may transmit request 202-4 to first website 110. Request 202-4 may indicate to web-component 112 that an operational error exists on first website 110. For example, request 202-4 may include instructions to redirect any attempt to access a given webpage of first website 110 to a corresponding webpage of second website 130. The instructions may cause web-component 112 to execute additional code to redirect any attempt to access first website 110 to second website 130.

In some embodiments, in response to first website 110 loading on user device 120, web-component 112 may execute code configured to detect an operational error on first website 110 using the same process as failover engine 102.

Web-component 112 may identify a web address for a webpage of second website 130 in the executable code embedded in first website 110. More specifically, based on the instructions, web-component 112 may execute code to identify a web address of second website 130. As indicated above, the executable code of web-component 112 may be tailored to a first website 110. Therefore, the web addresses of the webpages of second website 130 may be stored within a data structure in the executable code of web-component 112. For example, the web addresses of second website 130 may be stored as a structure, list, index, table, or the like. Furthermore, the web addresses of the different webpages of second website 130 may be correlated to corresponding web addresses of the webpages of first website 110. This way, the instructions may cause the web-component 112 to identify the web address of second website 130 stored in the data structure. Web-component 112 may transmit request 202-5 to second website 130 using the second website's identified web address 130. Request 202-5 may be user device 120's request 202-1 being redirected to second website 130. In response to transmitting request 202-5 to second website 130, second website 130 may be rendered on user device 120.

Web-component 112 may redirect any subsequent requests to access first website 110 to second website 130, while an operational error exists on first website 110. That is, each time there is an attempt to load first website 110 on user device 120 or any other device, web-component 112 may execute the executable code embedded in first website 110. The executable code may determine that an operational error exists on first website 110 and identify a web address for second website 130. The executable code may transmit a request to access second website 130 and for second website 130 to be loaded on user device 120. By doing so, web-component 112 may redirect any requests to access first website 110 to second website 130.

In some embodiments, failover engine 102 may transmit an alert to the first website's administrator, indicating an operational error on the first website 110. This may allow the administrator to resolve the operational error. This may result in reduced downtime of first website 110.

Second website 130 may mirror first website 110. As a non-limiting example, first website 110 may be a car dealership's website that allows users to view, inquire about, and purchase vehicles included in the car dealership's inventory. Similarly, second website 130 may allow users to view, inquire about, and purchase vehicles included in the car dealership's inventory.

Second website 130 may only include information about the inventory of a single dealership. Alternatively, second website 130 may include information about multiple car dealerships.

In some embodiments, web-component 112 may be included in different webpages of first website 110. More specifically, different webpages of first website 110 may include embedded executable code that is executed by web-component 112 in response to the webpage loading on user device 120 or any other device. Moreover, each webpage of first website 110 may correspond with a different webpage on second website 130. As a result, each webpage of first website 110 including the executable code, may include a web address for the corresponding webpage of second website 130 in the executable code.

First website 110 may receive a request to access a particular webpage of first website 110 to view a particular item, while an operational error exists on first website 110. The particular webpage may include information about a particular item (e.g., a particular vehicle). In response to the particular webpage of first website 110 loading on user device 120 or any other device, web-component 112 may execute the executable code embedded in the particular webpage. Based on the instructions, web-component 112 may execute code to identify a web address of a webpage of second website 130 that corresponds to the webpage of first website 110 that user device 120 is attempting to access. The webpage of second website 130 may include information about the particular item included on the particular webpage of first website 110. The executable code may transmit a request to access the webpage of second website 130 using the web address and for the webpage of second website 130 to be loaded on user device 120.

In some embodiments, failover engine 102 may determine that the operational error exists on the entire first website 110 based on the identified discrepancies and an attribute associated with the requests. For example, as indicated above, the GUI element may be rendered on multiple webpages of first website 110. The attribute may indicate that server 100 received less than a threshold number of requests over a time period from the multiple webpages of first website 110. The attribute may also indicate that more than a threshold number of requests received by server 100 included corrupt data from the multiple webpages of first website 110. As another example, the attribute may indicate that server 100 received less than a threshold number of requests over a time period from a particular geographic region from the multiple webpages of first website 110. Based on the identified attribute, failover engine 102 may determine that the operational error exists on the entire first website 110. As a result, failover engine 102 may transmit a request to web-component 112, including instructions to redirect any attempt to access any webpage of first website 110 to second website 130.

Additionally, failover engine 102 may determine that the operational error exists on a particular webpage of first website 110 based on the identified discrepancies and an attribute associated with the requests. For example, the attribute may indicate that server 100 received less than a threshold number of requests over a time period from the particular webpage of first website 110 while receiving at least the threshold number of requests over the time period from other webpages of first website 110. The attribute may also indicate that more than a threshold number of requests received by server 100 included corrupt data from the particular webpage of first website 110 while receiving less than the threshold number of requests with corrupt data from other webpages of first website 110. As another example, the attribute may indicate that server 100 received less than a threshold number of requests over a time period from a particular geographic region from the particular webpage of first website 110 while receiving at least the threshold number of requests over the time period from the particular geographic region from other webpages of first website 110. Based on the identified attribute, failover engine 102 may determine that the operational error exists on a particular webpage of first website 110. As a result, failover engine 102 may transmit a request to web-component 112 to indicate to web-component 112 that only the particular webpage includes the operational error. In this case, web-component 112 may only redirect requests to access the particular webpage of first website 110 to second website 130.

In some embodiments, failover engine 102 may determine that the operational error exists on first website 110 in a particular geographic region. For example, failover engine 102 may determine an attribute associated with the requests received by server 100 for a geographic region. The attribute may indicate that server 100 received less than a threshold number of requests over a time period from a particular geographic region from the multiple webpages or a particular webpage of first website 110. The attribute may also indicate that server 100 receives at least a threshold number of requests from first website 110 over the time period from other geographic regions. Based on the identified attribute, failover engine 102 may determine that there may be an outage of a server that supports first website 110 on the East Coast of the United States. Failover engine 102 may transmit a request to web-component 112, indicating to web-component 112 that the operational error exists on first website 110 in a particular geographic region. Web-component 112 may redirect requests to access first website 110 to second website 130 that originate from the particular geographic region.

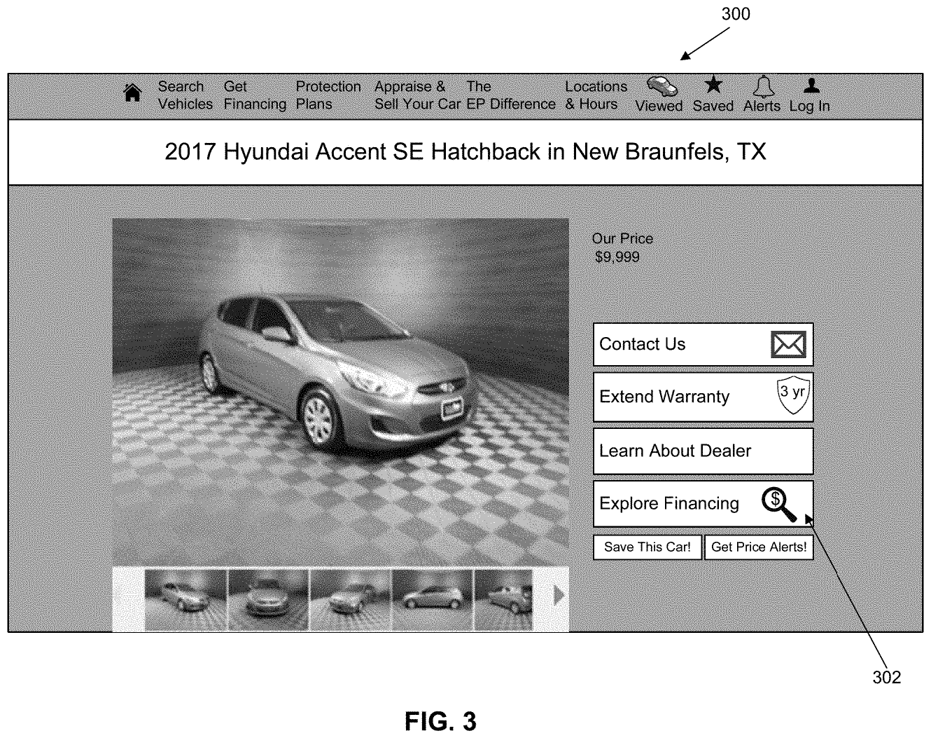

FIG. 3 illustrates a graphical user interface of a webpage of first website 110, according to some embodiments. FIG. 3 shall be described with reference to FIG. 1. As a non-limiting example, the first domain's website (e.g., first website 110) can be a car dealership's website. The car dealership's website may execute web-component 112. Furthermore, the car dealership's website may include multiple webpages, including webpage 300. The car dealership's website may be displayed on user device 120.

The web-component 112 may be configured to render button 302 each time webpage 300 is loaded. In some embodiments, the web-component may be configured to render button 302 or another GUI element on other webpages of the car dealership's website. Web-component 112 may be configured to use a web-scrapping algorithm to scrape the content on webpage 300 and generate an HTML, file including the content. Web-component 112 can transmit the HTML, file to a server (e.g., server 100, as shown in FIG. 1).

Webpage 300 may include information about a single vehicle. For example, webpage 300 may be displayed in response to a user selecting a vehicle from a different webpage of the car dealership's website. As such, the content may include information about the single vehicle. The content may include the make, model, price, year, VIN, or the like.

Web-component 112 may be configured to execute a web-scraping algorithm to scrape the content of other webpages of the car dealership's website in response to each of the other webpages loading on the user device. The other webpages may include information about multiple vehicles (e.g., a webpage that displays search results including multiple vehicles). As a result, the content scraped by the web-component may include information about the multiple vehicles.

The car dealership's website may include various links or buttons related to the purchase of the product. One of the links or buttons may include a button 302. Button 302 may be associated with transmitting a prequalification request for a loan for purchasing the specified product. In an embodiment, button 302 may be associated with transmitting a prequalification request for a loan for purchasing multiple products. In an embodiment, button 302 may be associated with each of a plurality of items (e.g., vehicles) displayed on webpage 30 to enable user selection of a product-specific prequalification request for any one or more of the displayed plurality of items.

In response to the actuation of button 302, the web-component can launch a website to be rendered within webpage 300. The website can be used to transmit a request to generate loan offers or prequalification results for the item(s) displayed on webpage 300.

In some embodiments, the website may be associated with server 100. For example, the website can be hosted by server 100 or can be associated with the same entity that manages server 100. Web-component 112 may execute the web-scraping algorithm to scrape the content of webpage 300 and generate an HTML file including the content in response to a user actuating button 302. Web-component 112 may transmit the HTML file to server 100 or another server responsible for generating the loan offers or prequalification results while launching the website.

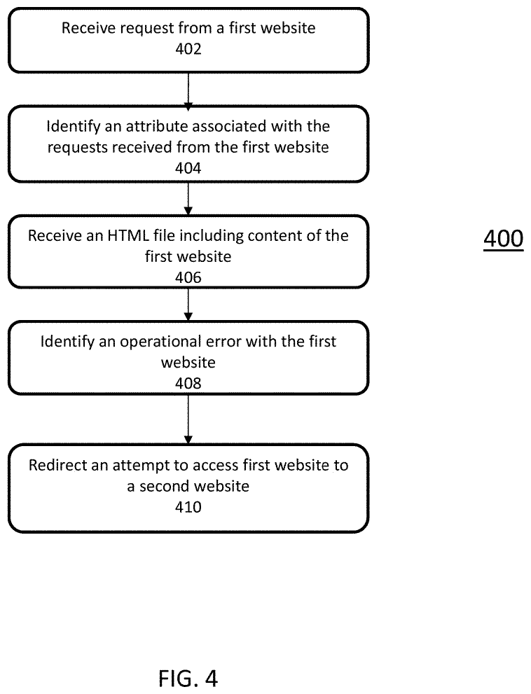

FIG. 4 is a flowchart illustrating a process for identifying an operational error with a first website, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 4, as will be understood by a person of ordinary skill in the art.

Method 400 shall be described with reference to FIG. 1. However, method 400 is not limited to those example embodiments.

In operation 402, server 100 receives requests from first website 110. First website 110 is a first domain's website. For example, the first website 110 may be a car dealership's website. The requests may be for generating a prequalification result for a loan for purchasing a vehicle from the car dealership. A user may transmit the request by interacting with a GUI element (e.g., a button) rendered on first website 110 using user device 120. The GUI element may be rendered using web-component 112, which includes executable code provided to the car dealership by an entity associated with server 100. Web-component 112 may be embedded in first website 110

In operation 404, failover engine 102 identifies an attribute associated with the requests from first website 110. The attribute may be a lower than a threshold number of requests received over a time period. Moreover, the attribute may be requests, including corrupt or unintelligible data. Alternatively, the attribute may be a lower than a threshold number of requests received from a particular geographic location over a time period.

In operation 406, failover engine 102 receives an HTML file including the content of first website 110 from web-component 112. Web-component 112 may be configured to extract the content of first website 110 in response to executing code embedded in first website 110. For example, the code may be an automated script. More specifically, web-component 112 may execute the automated script in response to one or more webpages of first website 110 loading on user device 120. The automated script may be a web-scraping algorithm configured to scrape the content of a given webpage of first website 110. Web-component 112 may include the scraped content in an HTML file and transmit the HTML file to server 100.

In operation 408, failover engine 102 identifies an operational error with first website 110 based on the attribute and the content of first website 110 included in the HTML file. Failover engine 102 may identify a discrepancy in the content of first website 110. The discrepancy may be the absence of content, unintelligible text, unexpected formatting, or the like. The operational error may indicate that first website 110 has crashed or is not functioning properly. Failover engine 102 may transmit an alert to the first domain (e.g., car dealership) to let them know the operational error with first website 110.

In operation 410, web-component 112 redirects an attempt to access first website 110 to a second website 130, in response to failover engine 102 identifying the operational error with first website 110 and while the operational error remains on first website 110. In the event a user attempts to access first website 110, and an operational error remains on first website 110 using user device 120, web-component 112 may identify an address for second website 130 and execute code to redirect the user to second website 130. The address for second website 130 may be included in the executable code embedded on first website 130. Web-component 112 may redirect user device 120 to navigate to second website 130 using the address of second website 130. Second website 130 may mirror first website 110. That is, if first website 110 includes items available at the first domain. Second website 130 may also include the same items available at the first domain. In some embodiments, if a user attempts to view a particular item on first website 110 while the operational error remains on first website 110, web-component 112 may identify the particular item the user is attempting to view, identify an address for a page of second website 130 that includes the particular item, and redirect user device 120 to the page of second website 130 including the particular item.

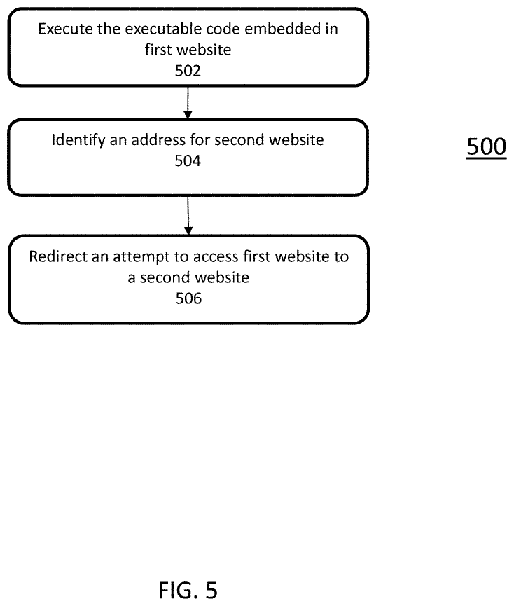

FIG. 5 is a flowchart illustrating a process for redirecting an attempt to access a first website to a second website, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 5, as will be understood by a person of ordinary skill in the art.

Method 500 shall be described with reference to FIG. 1. However, method 500 is not limited to those example embodiments.

In operation 502, web-component 112 executes the executable code embedded in first website 110 in response to an attempt received from a user device 120 to access first website 110, while an operational error exists on first website 110. User device 120 may attempt to load first website 110 on an Internet browser executing on user device 120. Web-component 112 may execute the executable code each time the first website 110 is loaded. Failover engine 102 may have previously determined that an operational error exists on first website 110 and may have indicated the operational error to web-component 112. As a result, the executable code may determine that there is an operational error on first website 110.

In operation 504, web-component 112 identifies an address for second website 130. The address for second website 130 may be included in the executable code embedded on first website 130. Second website 130 may mirror first website 110. That is if first website 110 includes items available at the first domain. Second website 130 may also include the same items available at the first domain. In some embodiments, executable code may be embedded in each webpage of first website 112. Moreover, the executable code for each webpage of first website 110 may have a different address for a corresponding webpage of second website 130. This way, if a user attempts to view a particular item on first website 110 while the operational error remains on first website 110, web-component 112 may identify the particular item the user is attempting to view and identify an address for a webpage of second website 130 that includes the particular item.

In operation 506, web-component 112 redirects user device 120's internet browser to navigate to the identified address of second website 130. Web-component 112 may redirect user device 120's internet browser to a particular webpage of second website 130.

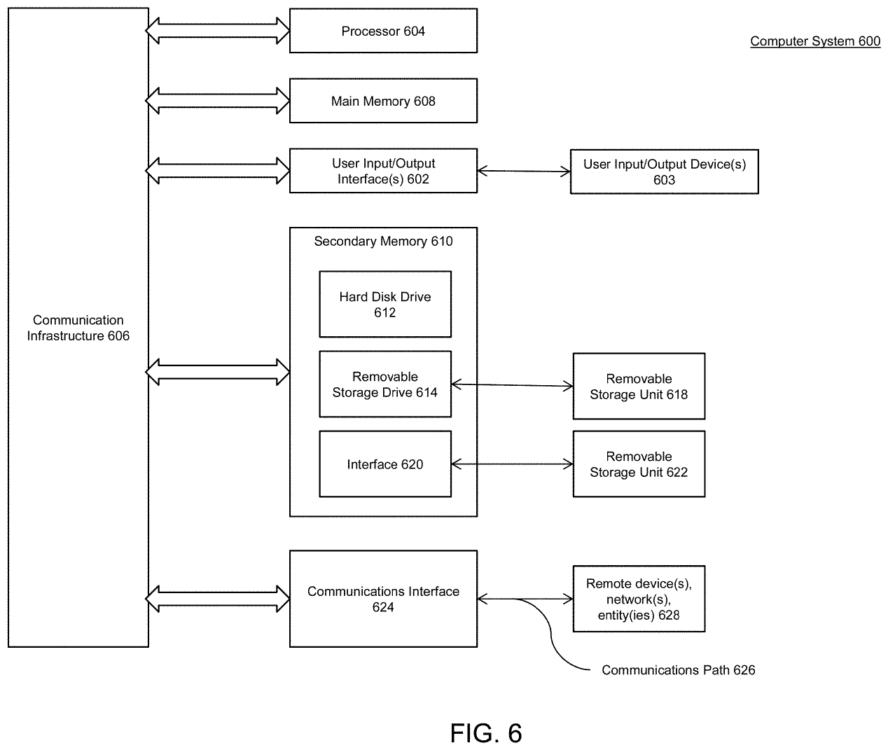

Various embodiments can be implemented, for example, using one or more computer systems, such as computer system 600 shown in FIG. 6. Computer system 600 can be used, for example, to implement methods 400 of FIG. 4 and 500 of FIG. 5. Furthermore, computer system 600 can be at least part of server 100, user device 120, and database 140, as shown in FIG. 1. For example, computer system 600 route communication to various applications. Computer system 600 can be any computer capable of performing the functions described herein.

Computer system 600 can be any well-known computer capable of performing the functions described herein.

Computer system 600 includes one or more processors (also called central processing units, or CPUs), such as a processor 604. Processor 604 is connected to a communication infrastructure or bus 606.

One or more processors 604 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 can include one or more levels of cache. Main memory 608 has stored therein control logic (i.e., computer software) and/or data.

Computer system 600 can also include one or more secondary storage devices or memory 610. Secondary memory 610 can include, for example, a hard disk drive 612 and/or a removable storage device or drive 614. Removable storage drive 614 can be a floppy disk drive, a magnetic tape drive, a compact disk drive, an optical storage device, tape backup device, and/or any other storage device/drive.

Removable storage drive 614 can interact with a removable storage unit 618. Removable storage unit 618 includes a computer usable or readable storage device having stored thereon computer software (control logic) and/or data. Removable storage unit 618 can be a floppy disk, magnetic tape, compact disk, DVD, optical storage disk, and/any other computer database. Removable storage drive 614 reads from and/or writes to removable storage unit 618 in a well-known manner.

According to an exemplary embodiment, secondary memory 610 can include other means, instrumentalities, or other approaches for allowing computer programs and/or other instructions and/or data to be accessed by computer system 600. Such means, instrumentalities, or other approaches can include, for example, a removable storage unit 622 and an interface 620. Examples of the removable storage unit 622 and the interface 620 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 can further include a communication or network interface 624. Communication interface 624 enables computer system 600 to communicate and interact with any combination of remote devices, remote networks, remote entities, etc. (individually and collectively referenced by reference number 628). For example, communication interface 624 can allow computer system 600 to communicate with remote devices 628 over communications path 626, which can be wired and/or wireless, and which can include any combination of LANs, WANs, the Internet, etc. Control logic and/or data can be transmitted to and from computer system 600 via communication path 626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method comprising:
receiving, by one or more computing devices, requests from a first website, wherein the first website is a first property of a first domain;
identifying, by the one or more computing devices, an attribute associated with the requests from the first website;
in response to executing code embedded in the first website, receiving, by the one or more computing devices and from a web-component configured to extract content of the first website, an HTML, file comprising the content of the first website, wherein the code is a second property of a second domain;
identifying, by the one or more computing devices, a discrepancy in the content, wherein the discrepancy is at least one of an absence of content, extra content, garbled text, unintelligible text, or unexpected formatting;
identifying, by the one or more computing devices, an operational error with the first website based on the attribute and the discrepancy in the content; and
in response to identifying the operational error with the first website and while the operational error remains on the first website, redirecting, by the one or more computing devices, using the web-component, an attempt to access the first website, to a second website, wherein the second website is a third property of the second domain.

2. The computer-implemented method of claim 1, wherein the attempt corresponds with accessing information about an item.

3. The computer-implemented method of claim 2, further comprising redirecting, by the one or more computing devices, the attempt to a page on the second website that includes the information about the item.

4. The computer-implemented method of claim 1, further comprising detecting, by the one or more computing devices, the attempt to access the first website in response to the first website executing the code embedded in the first website.

5. The computer-implemented method of claim 1, wherein the attribute indicates a number of requests received within a given timeframe is lower than a threshold amount.

6. The computer-implemented method of claim 1, wherein the attribute indicates that a number of requests received from a geographic region within a given timeframe is lower than a threshold amount.

7. The computer-implemented method of claim 6, further comprising redirecting, by the one or more computing devices, any attempt to access the first website received from the geographic region to the second website.

8. The computer-implemented method of claim 1, wherein content of the second website mirrors the content of the first website.

9. The computer implemented method of claim 1, wherein the web-component executes a web scraping algorithm to extract the content from the first website.

10. A system comprising:
a memory;
a processor coupled to the memory, wherein the processor is configured to:
receive requests from a first website, wherein the first website is a first property of a first domain;
identify an attribute associated with the requests from the first website;
in response to executing code embedded in the first website, receive, from a web-component configured to extract content of the first website, an HTML, file comprising the content of the first website, wherein the code is a second property of a second domain;
identify a discrepancy in the content, wherein the discrepancy is at least one of an absence of content, extra content, garbled text, unintelligible text, or unexpected formatting;
identify an operational error with the first website based on the attribute and the discrepancy in the content; and
in response to identifying the operational error with the first website and while the operational error remains on the first website, redirect, using the web-component, an attempt to access the first website, to a second website, wherein the second website is a third property of the second domain.

11. The system of claim 10, wherein the attempt corresponds with accessing information about an item.

12. The system of claim 11, wherein the processor is further configured to redirect the attempt to a page on the second website that includes the information about the item.

13. The system of claim 10, wherein the processor is further configured to detect the attempt to access the first website in response to the first website executing the code embedded in the first website.

14. The system of claim 10, wherein the processor is further configured to redirect any attempt to access the first website received from a geographic region to the second website based on the attribute indicating that a number of requests received from the geographic region within a given timeframe is lower than a threshold amount.

15. The system of claim 10, wherein content of the second website mirrors the content of the first website.

16. A non-transitory computer-readable medium having instructions stored thereon, execution of which, by one or more processors of a device, cause the one or more processors to perform operations comprising:
receiving requests from a first website, wherein the first website is a first property of a first domain;
identifying an attribute associated with the requests from the first website;
in response to executing code embedded in the first website, receiving, from a web-component configured to extract content of the first website, an HTML file comprising the content of the first website, wherein the code is a second property of a second domain;
identifying a discrepancy in the content, wherein the discrepancy is at least one of an absence of content, extra content, garbled text, unintelligible text, or unexpected formatting;
identifying an operational error with the first website based on the attribute and the discrepancy in the content; and
in response to identifying the operational error with the first website and while the operational error remains on the first website, redirecting, using the web-component, an attempt to access the first website, to a second website, wherein the second website is a third property of the second domain.

17. The non-transitory computer-readable medium of claim 16, wherein the attempt corresponds with accessing information about an item.

18. The non-transitory computer-readable medium of claim 17, wherein the operations further comprising redirecting the attempt to a page on the second website that includes the information about the item.

19. The non-transitory computer-readable medium of claim 16, wherein the operations further comprising detecting the attempt to access the first website in response to the first website executing the code embedded in the first website.

20. The non-transitory computer-readable medium of claim 16, wherein the operations further comprising redirecting any attempt to access the first website received from a geographic region to the second website based on the attribute indicating that a number of requests received from the geographic region within a given timeframe is lower than a threshold amount.
